(19) United States
(12) Patent Application Publication
(10) Pub. No.: US 2011/0173355 A1
(43) Pub. Date: Jul. 14, 2011

(54) Method for setting and controlling hot key area of keyboard via KVM switch

(75) Inventors: Sharon Lin Charna, Irvine, CA (US); Christian Cruzado, Irvine, CA (US); Jim Gau, Irvine, CA (US); Jose Lardizabal, Irvine, CA (US)

(73) Assignee: At Box Technology Inc., Irvine, CA (US)

(21) Appl. No.: 12/805,358

(22) Filed: Jul. 27, 2010

Related U.S. Application Data
(60) Provisional application No. 61/335,817, filed on Jan. 13, 2010.

(30) Foreign Application Priority Data
May 25, 2010 (TW) 099116637

(51) Int. Cl. G06F 13/12

(52) U.S. Cl. 710/67

(57) ABSTRACT

The present invention is to provide a method for setting and controlling a hot key area of a keyboard via a keyboard-video-mouse (KVM) switch electrically connected to the keyboard, a mouse, a monitor and a plurality of servers and provided therein with a flag and a hot key lookup table. When the KVM switch receives an instruction command for activating a direct hot key (DHK) state from the keyboard, the KVM switch sets the flag to an activated state for entering into the DHK state, and then sets a numeric key area and/or a function key area of the keyboard as a hot key area. Thus, when the KVM switch receives a management command matching with the hot key lookup table, the KVM switch executes a server switching procedure corresponding to the management command, thereby switching to a specified server and displaying a corresponding server image on the monitor.

### FIELD OF THE INVENTION

The present invention relates to a keyboard-video-mouse (KVM) switch, more particularly to a method for setting and controlling a hot key area of a keyboard via a KVM switch, so as to enable a network manager to easily activate the KVM switch entering into a direct hot key (DHK) state and then directly press keys in a hot key area of the keyboard to switch to an intended server, which is far more convenient than conventional controlling method in which it is required to press multiple hot keys of a keyboard to switch to a different server.

### BACKGROUND OF THE INVENTION

With the advancement of microcomputer technology and the high development of the network industry, may enterprises have adopted electronic operating procedures. To facilitate data management between different departments and ensure that data of different classification levels will not be mixed up, it is common practice for an enterprise to use a plurality of servers to store and process the data of different departments respectively, which nevertheless increases the number of servers in the server room or on the desktop. Given the limited space in the server room or on the desktop, it is impractical to equip each and every server with a keyboard, a mouse, and a monitor, for such arrangement not only takes up a huge amount of space but also requires the purchase of a large number of computer peripherals, which in turn raises the costs of network management. In addition, if each server is provided with a keyboard, a mouse, and a monitor, a network manager must change positions constantly to operate each keyboard or mouse properly.

In order to reduce the costs of network management and enable effective use of space, a keyboard-video-mouse (KVM) switch is typically used. Generally, a KVM switch is electrically connected to one keyboard, one mouse, one monitor, and a plurality of servers. By switching the KVM switch, a network manager can switch to the server to be controlled (say, server A), and in consequence the KVM switch displays the image of server A on the monitor and delivers signals from the keyboard and the mouse to server A. Thus, the network manager can operate server A with the keyboard, the mouse, and the monitor as if the latter three peripherals were directly connected to server A. When it is desired to control another server (say, server B), the KVM switch is switched to server B so as to deliver signals from the keyboard and the mouse to server B and display the image of server B on the monitor. As only one keyboard, one mouse, and one monitor are needed to manage a plurality of servers, network management is made easy, and space in the server room or on the desktop is freed.

However, while the conventional KVM switch is effective in managing multiple servers with only one keyboard, one mouse, and one monitor, the switching between different servers cannot be completed without entering complicated hot key combinations, which becomes a source of inconvenience to network managers. For instance, if it is desired to switch to the fifth of twelve servers connected to a KVM switch, it is necessary to press a hot key combination of the keys “Scroll Lock” (twice), “0”, and “5”. Besides, while the key “Scroll Lock” is pressed repeatedly, the time interval must not be too short (e.g., shorter than 0.5 second) or too long (e.g., longer than 1.5 second); otherwise, the KVM switch will fail to switch due to misjudgment, and the same hot key combination will have to be pressed again. In addition, as the plural servers must be monitored constantly, the switching between different servers is performed on a regular basis. However, with the conventional hot key combinations which require the key “Scroll Lock” be pressed repeatedly and with proper interval to complete the server switching process, the convenience brought about by the KVM switch is compromised.

According to the above, the hot key combinations of the conventional KVM switch involve too many keys, must be pressed under strict conditions, and hence cause inconvenience to network managers. Therefore, it is an important subject in the KVM switch industry to develop a novel control method that facilitates network managers' operation.

### BRIEF SUMMARY OF THE INVENTION

In view of the fact that the hot key combinations of existing KVM switches are disadvantageous to network managers' operation and leave much room for improvement, the inventor of the present invention, after conducting extensive research and experiment, succeeded in developing a method for setting and controlling a hot key area of a keyboard via a KVM switch, so as to solve the aforesaid drawbacks of the prior art effectively.

It is an object of the present invention to provide a method for setting and controlling a hot key area of a keyboard via a KVM switch. The method is applicable to a KVM switch which is electrically connected to a keyboard, a mouse, a monitor, and a plurality of servers and which is provided therein with a flag and a hot key lookup table. When the KVM switch receives a first instruction signal transmitted from the keyboard and determines that the first instruction signal includes a command for activating a direct hot key (abbreviated hereinafter as DHK) state, the KVM switch sets the flag to an activated state and thus enters the DHK state. Meanwhile, the KVM switch sets a numeric key area (including the keys “1”, “2”, “3”, etc.) and/or a function key area (including the keys “Home”, “End”, “PageUp”, “PageDown”, etc.) of the keyboard as a hot key area. When subsequently receiving a management instruction signal, the KVM switch reads a command in the management instruction signal and determines whether or not the flag is in the activated state. If the flag is in the activated state, the KVM switch matches the command against the hot key lookup table and executes a server switching procedure corresponding to the command, thereby switching to the specified server and displaying a corresponding server image on the monitor. Thus, with the setting and controlling method of the present invention, a network manager only has to activate the DHK state and directly press keys (e.g., “0” and “5”) in the hot key area of the keyboard to switch to the intended server, which is far more convenient than the conventional controlling method in which it is required to press multiple hot keys (e.g., “Scroll Lock” (twice), “0”, and “5”) to switch to a different server.

### BRIEF DESCRIPTION OF THE SEVERAL VIEWS OF THE DRAWINGS

The invention as well as a preferred mode of use, further objects, and advantages thereof will be best understood by referring to the following detailed description of some illustrative embodiments in conjunction with the accompanying drawings, in which:

FIG. 1 is a hardware block diagram of a KVM switch according to the present invention;

FIG. 2 shows an on-screen menu according to the present invention;

FIG. 3 shows a keyboard set with a hot key area;

FIG. 4 is a flowchart of a setting method according to the present invention; and

FIG. 5 is a flowchart of a controlling method according to the present invention.

### DETAILED DESCRIPTION OF THE INVENTION

The present invention provides a method for setting and controlling a hot key area of a keyboard via a keyboard-video-mouse (KVM) switch, and the method is applied to the KVM switch. It should be noted that the terminology used in the following description of the preferred embodiments of the present invention serves explicative purposes only and should not be construed as restrictive. Furthermore, the hardware connections in the disclosed embodiments of the present invention are only illustrative, allowing the general public or persons skilled in the art to readily appreciate the substance and essence of the subject matter of the present invention, but are not limited to the configurations described herein. A person of skill in the art who has learned the principal technical features of the present invention may use other structures, devices, systems, and methods to realize the above and other objects of the present invention. Therefore, all equivalent structures which do not depart from the spirit and principles of the present invention should fall within the scope of the appended claims.

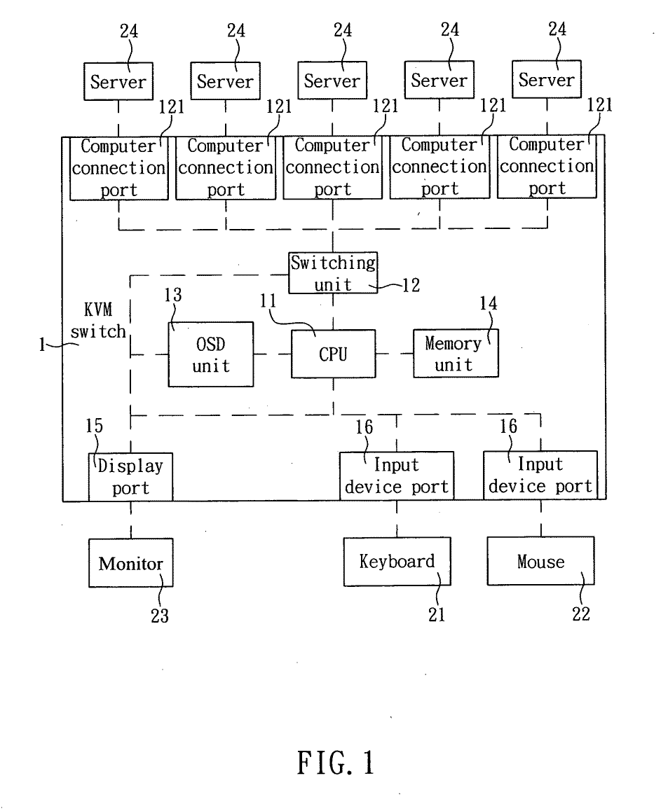

Referring to FIG. 1, in a preferred embodiment of the present invention, a KVM switch 1 is electrically connected to a keyboard 21, a mouse 22, a monitor 23, and a plurality of servers 24 so as for a network manager to control each server 24 by the keyboard 21 or the mouse 22 and to view the image of each server 24 on the monitor 23. The KVM switch 1 includes a central processing unit (CPU) 11, a switching unit 12, a plurality of computer connection ports 121, an on-screen display (OSD) unit 13, a memory unit 14, a display port 15, and at least one input device port 16. The memory unit 14 is provided therein with a flag, an OSD lookup table, and a hot key lookup table. The CPU 11 is respectively and electrically connected to the switching unit 12, the OSD unit 13, the memory unit 14, the display port 15, and each input device port 16. The CPU 11 is configured for receiving signals from the switching unit 12, the OSD unit 13, the display port 15, and each input device port 16 and sending control signals (e.g., video signals, audio signals, command signals, etc.) to the switching unit 12, the OSD unit 13, the memory unit 14, and the display port 15 so as for the switching unit 12, the OSD unit 13, the memory unit 14, and the display port 15 to execute corresponding procedures or send out corresponding data. The input device ports 16 are connected to the keyboard 21 and the mouse 22, respectively, so as for the CPU 11 to process instruction signals transmitted by the keyboard 21 and the mouse 22.

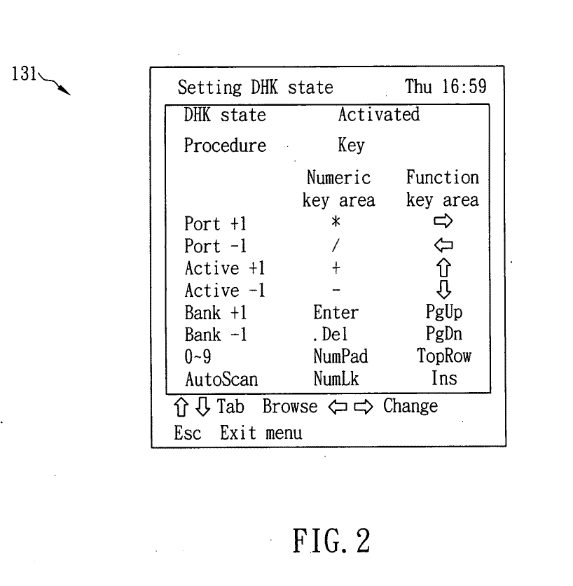

As shown in FIG. 1, the computer connection ports 121 of the KVM switch 1 are respectively and electrically connected to the servers 24 and the switching unit 12. The switching unit 12 delivers the control signals transmitted from the CPU 11 to the specified computer connection port 121 and consequently to the corresponding server 24. The switching unit 12 also receives signals from a specified server 24. In addition, the switching unit 12 is electrically connected to the display port 15 so as to deliver video signals from a specified server 24 directly to the display port 15, thus allowing the monitor 23 to display the image of the specified server 24. In a different embodiment of the present invention, however, the switching unit 12 is configured for transmitting the video signals to the CPU 11, which in turn transmits the video signals to the display port 15. The OSD unit 13 is electrically connected to the display port 15 and is configured for transmitting a menu signal through the display port 15 to the monitor 23 so as for the monitor 23 to display an on-screen menu 131 (as shown in FIG. 2) which shows preset options and information. While the on-screen menu 131 in FIG. 2 shows only words, the content of the on-screen menu 131 may vary according to design needs and include figures or other symbols instead of words, with a view to increasing the industrial applicability of the present invention.

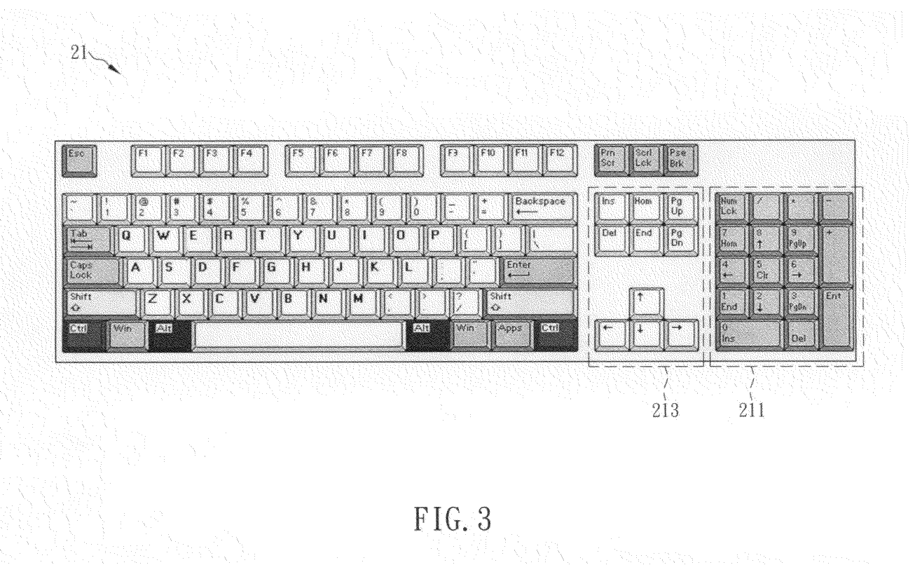

Referring to FIG. 1 and FIG. 3, in order to activate a direct hot key (abbreviated hereinafter as DHK) state, a network manager presses a hot key combination on the keyboard 21 (e.g., the key “Scroll Lock” and the space bar). As a result, the keyboard 21 transmits a menu activation signal to the CPU 11 through the corresponding input device port 16. The CPU 11 receives the menu activation signal, reads the key code values therein, and after determining that the menu activation signal includes a command (i.e., the key code value of the key “Scroll Lock” and the key code value of the space bar) for invoking an OSD menu, transmits a first control instruction to the OSD unit 13. Consequently, the OSD unit 13 sends the menu signal to the monitor 23, and the monitor 23 displays the on-screen menu 131 (as shown in FIG. 2). When the network manager sees the on-screen menu 131 and subsequently presses keys on the keyboard 21, the CPU 11 receives a first instruction signal from the keyboard 21. The CPU 11 matches a command (i.e., the key code values) in the first instruction signal against the OSD lookup table stored in the memory unit 14 and, after determining that the first instruction signal includes a command for activating the DHK state, sets the flag stored in the memory unit 14 to an activated state (e.g., setting the flag as “1”), thus bringing the KVM switch 1 into the DHK state. Meanwhile, a numeric key area 211 (including the keys “1”, “2”, “3”, etc.) and/or a function key area 213 (including the keys “Home”, “End”, “PageUp”, “PageDown”, etc.) of the keyboard 21 are set as a hot key area. When it is desired to switch to a particular server 24 (e.g., the fifth server 24), the network manager only has to press the keys “0” and “5” in the numeric key area 211 of the keyboard 21, such that the CPU 11 receives a management instruction signal and reads a command therein (e.g., the key code value of the key “0” and the key code value of the key “5”) as well as the current state of the flag. Since the flag is in the activated state, the CPU 11 matches the command in the management instruction signal against the hot key lookup table stored in the memory unit 14 and, upon reading the server switching procedure corresponding to the command (e.g., switching to the fifth server 24), transmits a second control instruction to the switching unit 12, thereby driving the switching unit 12. Consequently, the server 24 corresponding to the fifth computer connection port 121 transmits a video signal of its own image to the display port 15 so as for the monitor 23 to display the image of the fifth server 24. Hence, with the setting and controlling method of the present invention, a network manager can easily activate or deactivate the DHK state of the KVM switch 1, convert the numeric key area 211 and/or the function key area 213 of the keyboard 21 into the hot key area when the KVM switch 1 is in the DHK state, and switch to the intended server 24 by directly pressing keys in the hot key area, rather than by having to press the key “Scroll Lock” twice to initiate each server switching procedure, as is required in the conventional controlling method. The setting and controlling method of the present invention not only effectively reduces the number of keys in each hot key combination but also allows intuitive operation, which increases the learning efficiency of network management personnel and effectively enhances the convenience brought about by the KVM switch 1. In addition, when the menu activation signal, the first instruction signal, and the management instruction signal do not include commands executable by the KVM switch 1, the KVM switch 1 transmits those signals to the server 24 corresponding to the currently specified computer connection port 121 so as for that particular server 24 to execute the corresponding procedures.

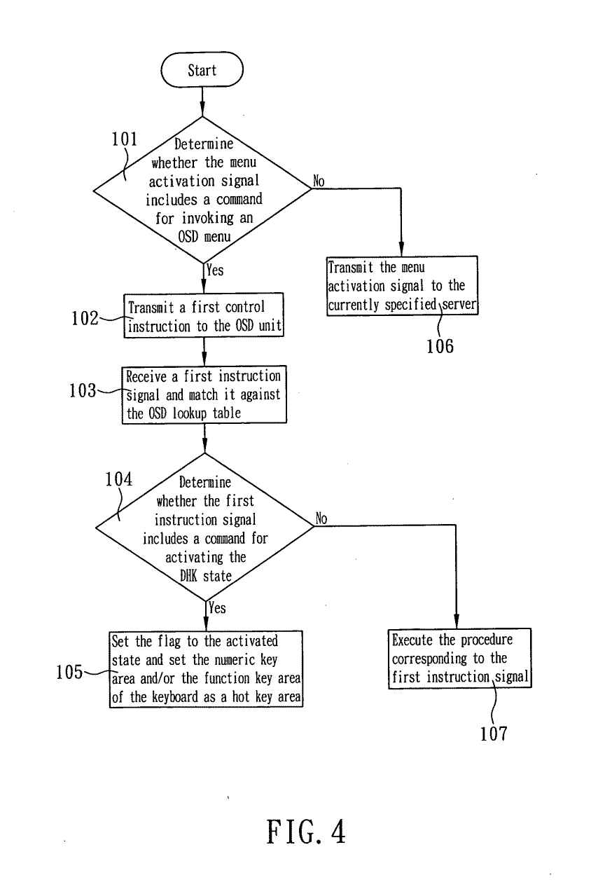

The setting steps and the controlling steps of the present invention are further demonstrated with the processing procedure of the CPU 11. Referring to FIG. 4 in conjunction with FIG. 1, the CPU 11, upon receiving a menu activation signal, performs the following steps.

Step 101: The CPU 11 determines whether or not the menu activation signal includes a command for invoking an OSD menu. If yes, the procedure goes on to Step 102; otherwise, Step 106 is executed.

Step 102: The CPU 11 transmits a first control instruction to the OSD unit 13. Then, the procedure continues to Step 103.

Step 103: The CPU 11 receives a first instruction signal, reads a command in the first instruction signal, and matches the command against the OSD lookup table. After that, Step 104 is executed.

Step 104: The CPU 11 determines whether or not the first instruction signal includes a command for activating the DHK state. If yes, go to Step 105; otherwise, go to Step 107.

Step 105: The CPU 11 sets the flag to the activated state and sets the numeric key area 211 and/or the function key area 213 of the keyboard 21 as a hot key area, thereby bringing the KVM switch 1 into the DHK state.

Step 106: The CPU 11 transmits the menu activation signal through the switching unit 12 to the server 24 corresponding to the currently specified computer connection port 121.

Step 107: The CPU 11 executes the procedure corresponding to the first instruction signal.

With the setting procedure stated above, a network manager can activate the DHK state rapidly and define the numeric key area 211 and/or the function key area 213 of the keyboard 21 as the hot key area. Generally speaking, a network manager rarely uses the numeric key area 211 and the function key area 213 of the keyboard 21 while managing the servers 24; therefore, setting those areas as the hot key area will not interfere with the work of the network manager but allow full use of the keyboard 21. It should be pointed out that the menu activation signal may be transmitted by the mouse 22 instead of the keyboard 21. Alternatively, a pushbutton is additionally provided at the input device ports 16 of the KVM switch 1 so that, by pressing the pushbutton, a menu activation signal containing the command for invoking the OSD menu is sent. In other words, KVM switches 1 of different models may have different input methods for invoking the OSD menu. Moreover, in a different embodiment of the present invention, the KVM switch 1 lacks the OSD unit 13, and the DHK state is activated simply by pressing the hot key for activating the DHK state. In cases where the KVM switch 1 lacks the OSD unit 13, the memory unit 14 is not stored with the OSD lookup table. Hence, upon receiving the first instruction signal, the CPU 11 directly determines whether or not the first instruction signal includes the command for activating the DHK state, and if yes, the KVM switch 1 enters the DHK state immediately. The production costs of the KVM switch 1 can be effectively reduced by dispensing with the OSD unit 13. Besides, in the foregoing embodiments, the terms “menu activation signal”, “first instruction signal”, and the like are differentiated from one another solely to enable rapid understanding of the technical features of the present invention.

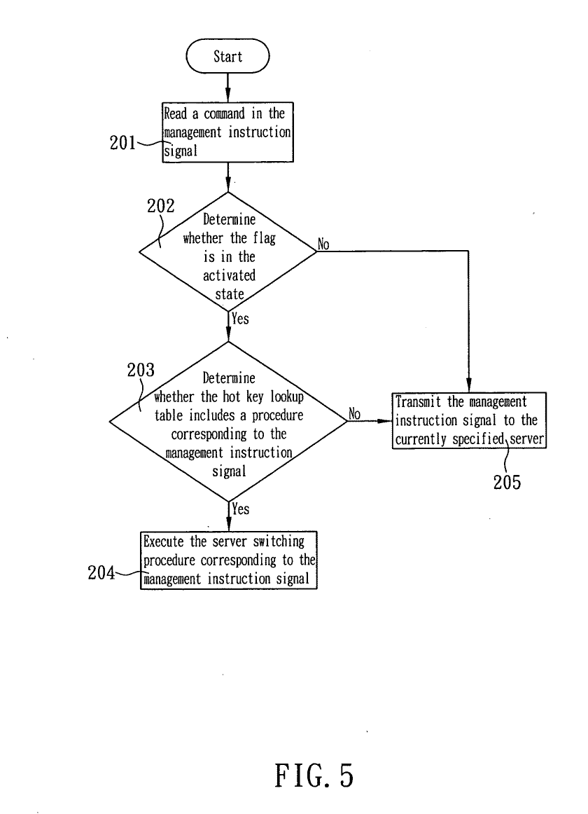

Referring to FIG. 5 in conjunction with FIG. 1, after the aforesaid setting procedure is completed, the CPU 11 performs the following steps upon receiving a management instruction signal.

Step 201: The CPU 11 reads a command in the management instruction signal. Then, Step 202 is executed.

Step 202: The CPU 11 determines whether or not the flag in the memory unit 14 is in the activated state. If yes, go to Step 203; otherwise, go to Step 205.

Step 203: The CPU 11 matches the command in the management instruction signal against the hot key lookup table and determines whether or not the hot key lookup table includes a server 24 switching procedure corresponding to the command. If yes, go to Step 204; otherwise, go to Step 205.

Step 204: The CPU 11 executes the server 24 switching procedure in the hot key lookup table that corresponds to the management instruction signal.

Step 205: The CPU 11 transmits the management instruction signal through the switching unit 12 to the server 24 corresponding to the currently specified computer connection port 121.

With the controlling procedure described above, and under the condition that the DHK state of the KVM switch 1 is activated and that the numeric key area 211 and/or the function key area 213 of the keyboard 21 are set as the hot key area, a network manager only has to press keys in the numeric key area or the function key area to switch to different servers 24. By contrast, the conventional controlling method requires a combination of more hot keys (e.g., the keys “Scroll Lock” (twice), “0”, and “5”) be pressed to switch to each server 24. Therefore, the controlling procedure of the present invention significantly enhances the convenience of management over different servers 24. In addition, as the hot key lookup table is stored in the KVM switch 1, the setting and controlling method of the present invention allows the hot key area to be set on an ordinary keyboard 21 rather than a special keyboard 21, thereby eliminating the need to purchase additional keyboards.

According to the above, the setting and controlling method of the present invention is capable of achieving the following effects:

1. A network manager who wishes to switch between different servers can do so by directly pressing keys in the numeric key area or the function key area. Thus, the operation is made easy, and the number of hot keys that need to be pressed by the network manager is reduced.

2. As the hot key area is set on an ordinary keyboard, there is no need to use specially made keyboards, and therefore the applicability of the KVM switch is effectively increased.

3. As the operation is intuitive, the difficulty encountered by network management personnel in learning how to operate the KVM switch is reduced.

It should be particularly pointed out that, while only one memory unit is provided in the foregoing embodiments, it is feasible to use multiple memory units as well, such that the flag, the OSD lookup table, and the hot key lookup table are stored in different memory units. The OSD lookup table and the hot key lookup table may also be combined into one lookup table. Besides, the CPU, the switching unit, the OSD unit, and the memory unit can be integrated into one chip, or the OSD unit can be designed as an independent plug-in device and stores the flag, the OSD lookup table, and the hot key lookup table. In the latter case, a network manager only has to buy the independently provided OSD unit and install it on the KVM switch to perform the setting and controlling method of the present invention.

The embodiments described above are only the preferred embodiments and are not intended to limit the scope of the present invention, which is defined by the appended claims. Therefore, all equivalent changes which are based on the technical content disclosed herein and easily conceivable by a person skilled in the art should fall within the scope of the claims.

What is claimed is:

1. A method for setting a hot key area of a keyboard via a keyboard-video-mouse (KVM) switch, the method being applied to the KVM switch, the KVM switch comprising a central processing unit (CPU), a switching unit, a plurality of computer connection ports, a memory unit, a display port, and at least an input device port; the CPU being respectively and electrically connected to the switching unit, the memory unit, the display port, and each said input device port; the switching unit being respectively and electrically connected to each said computer connection port and the display port; the memory unit storing a flag and a hot key lookup table; the at least an input device port being respectively and electrically connected to the keyboard and an optional mouse; wherein the method comprises steps, performed by the CPU upon receiving a first instruction signal transmitted from the at least an input device port, of:
determining whether or not the first instruction signal includes a command for activating a direct hot key (DHK) state; and
setting the flag to an activated state and setting a numeric key area and/or a function key area of the keyboard as the hot key area, when it is determined that the first instruction signal includes the command for activating the DHK state.

2. The method of claim 1, wherein the KVM switch further comprises an on-screen display (OSD) unit, the memory unit further stores an OSD lookup table, and the method further comprises steps, performed by the CPU before receiving the first instruction signal, of:
receiving and reading a menu activation signal transmitted from the at least an input device port;
determining whether or not the menu activation signal includes a command for invoking an OSD menu; and
transmitting a first control instruction to the OSD unit when it is determined that the menu activation signal includes the command for invoking the OSD menu, so as for the OSD unit to transmit a menu signal to the display port and for the CPU, upon receiving the first instruction signal, to match a command in the first instruction signal against the OSD lookup table, thereby determining whether or not the first instruction signal includes the command for activating the DHK state.

3. The method of claim 2, wherein the keyboard transmits the first instruction signal or the menu activation signal to a corresponding said input device port.

4. A method for controlling a hot key area of a keyboard via a keyboard-video-mouse (KVM) switch, the method being applied to the KVM switch, the KVM switch comprising a central processing unit (CPU), a switching unit, a plurality of computer connection ports, a memory unit, a display port, and at least an input device port; the CPU being respectively and electrically connected to the switching unit, the memory unit, the display port, and each said input device port; the switching unit being respectively and electrically connected to each said computer connection port and the display port; the memory unit storing a flag and a hot key lookup table; the at least an input device port being respectively and electrically connected to the keyboard and an optional mouse; the KVM switch being in a direct hot key (DHK) state; a numeric key area and/or a function key area of the keyboard being set as the hot key area; wherein the method comprises steps, performed by the CPU upon receiving a management instruction signal transmitted from the at least an input device port, of:
reading a command in the management instruction signal;
determining whether or not the flag is in an activated state;
matching the command in the management instruction signal against the hot key lookup table when it is determined that the flag is in the activated state;
determining whether or not the management instruction signal includes a server switching procedure in the hot key lookup table; and
executing the server switching procedure when it is determined that the management instruction signal includes the server switching procedure.

5. The method of claim 4, wherein in order to set the hot key area, the method further comprises steps, performed by the KVM switch before entering the DHK state, of:
receiving and reading a first instruction signal;
determining whether or not the first instruction signal includes a command for activating the DHK state; and
setting the flag to the activated state and setting the numeric key area and/or the function key area of the keyboard as the hot key area, when it is determined that the first instruction signal includes the command for activating the DHK state.

6. The method of claim 4, wherein the KVM switch further comprises an on-screen display (OSD) unit, the memory unit further stores an OSD lookup table, and in order to set the hot key area, the method further comprises steps, performed by the KVM switch before entering the DHK state, of:
receiving and reading a menu activation signal;
determining whether or not the menu activation signal includes a command for invoking an OSD menu;
transmitting a first control instruction to the OSD unit when it is determined that the menu activation signal includes the command for invoking the OSD menu, so as for the OSD unit to transmit a menu signal to the display port;
receiving and reading a first instruction signal and matching a command in the first instruction signal against the OSD lookup table;
determining whether or not the first instruction signal includes a command for activating the DHK state; and
setting the flag to the activated state and setting the numeric key area and/or the function key area of the keyboard as the hot key area, when it is determined that the first instruction signal includes the command for activating the DHK state.

7. The method of claim 5, wherein the computer connection ports of the KVM switch are respectively and electrically connected to a plurality of servers, and the method further comprises a step, performed by the CPU upon determining that the management instruction signal does not include any procedure in the hot key lookup table, of transmitting the management instruction signal through the switching unit to a said server corresponding to a currently specified said computer connection port.

8. The method of claim 6, wherein the computer connection ports of the KVM switch are respectively and electrically connected to a plurality of servers, and the method further comprises a step, performed by the CPU upon determining that the management instruction signal does not include any procedure in the hot key lookup table, of transmitting the management instruction signal through the switching unit to a said server corresponding to a currently specified said computer connection port.
